(19) United States
(12) Patent Application Publication
(10) Pub. No.: US 2010/0011993 A1
(43) Pub. Date: Jan. 21, 2010

(54) Method for the production of coarse-scale and/or nanoscale, coated, de-agglomerated magnesium hydroxide particles

(76) Inventors: David Christopher Glende, Bovenden (DE); Ingo Stahl, Vellmar (DE); Stefan Dressel, Kassel (DE)

Correspondence Address: COLLARD & ROE, P.C., 1077 NORTHERN BOULEVARD, ROSLYN, NY, 11576, US

(21) Appl. No.: 12/459,547

(22) Filed: Jul. 2, 2009

(30) Foreign Application Priority Data
Jul. 4, 2008 (DE) 10 2008 031 361.0

(51) Int. Cl. C09D 7/12

(52) U.S. Cl. 106/461

(57) ABSTRACT

The present invention relates to a method for the production of coated magnesium hydroxide particles, whereby the individual primary magnesium hydroxide particles are coated. According to the invention, specific additives are added to the precipitation reaction for obtaining the magnesium hydroxide particles, in order to obtain these magnesium hydroxide particles in a coated state. Furthermore, a first method step of the present invention is directed at a method for the production of coarse-scale or nanoscale, coated magnesium hydroxide suspensions or dispersions. In a second method step, the coated magnesium hydroxide particles can be converted to de-agglomerated products either by means of bead-mill grinding or ultrasound and a dispersant. Finally, the present invention is directed at coated magnesium hydroxide particles, particularly nanoscale, coated magnesium hydroxide particles that can be obtained in this manner.

The present invention relates to a method for the production of coated magnesium hydroxide particles, whereby the individual primary magnesium hydroxide particles are coated. According to the invention, certain additives are added to the precipitation reaction for obtaining the magnesium hydroxide particles, in order to keep these magnesium hydroxide particles in a coated state, whereby every primary particle carries its own coating. An aqueous suspension or dispersion is obtained, which is suitable for direct further processing. Furthermore, the present invention is directed at a method for the production of coarse-scale or nanoscale, coated, de-agglomerated magnesium hydroxide particles, comprising the treatment of (pre)coated magnesium hydroxide particles, either by means of bead-mill grinding or ultrasound, with a dispersant. Finally, the present invention is directed at coated magnesium hydroxide particles that can be obtained in this manner, particularly nanoscale, coated magnesium hydroxide particles.

### STATE OF THE ART

It is generally known that fillers are introduced into plastics to modify their properties and also for cost reduction. These fillers can be both coarse-scale and nanoscale with regard to their particle size, and are generally used as dried powders.

In order to be worked into thermoplastic plastics, these fillers can be supplied to the extruder as finely ground powders. In order to be worked into duroplastic materials, the dried and ground powders are generally combined with liquid resins (monomers or oligomers), then homogenized, for example by means of an intensive stirrer, and subsequently polymerized, after addition of a resin.

Coarse-scale magnesium hydroxide having surface areas of 4 to 10 m²/g is used as a flame-inhibiting filler in various plastics, at filler contents of at least 50 wt.-%. There are a large number of nanoscale fillers having the most varied chemical nature. These nanoscale filler are frequently present as a powder that consists of agglomerated nanoparticles. These agglomerates, on a micrometer scale, however, do not lead to the desired mechanical improvements of the polymer materials. This means that polymer materials are obtained in which agglomerated nanoparticles in the micrometer range are present, having the mechanical property profile of coarse-scale fillers.

In the case of thermoplastic or duroplastic materials in which the nanoscale, dried filler can be mixed with the resin by means of a dissolver, as a form of an intensive stirrer, only a fraction of the agglomerates can be destroyed. When the fillers are worked into thermoplastic plastics and into monomers or oligomers from which duroplastic materials are produced, the shear forces applied for homogenization by using intensive stirrers are not sufficient for complete de-agglomeration of the fillers.

In WO99/08962, wet grinding of a magnesium hydroxide slurry with the addition of cationic polymers as a dispersant is described. These magnesium hydroxide particles obtained there have disadvantages, however, inasmuch as they are not well suited for being worked into polymers. Also, the two-step method described there is complicated. An adaptation of the polarity of the particles to the subsequent polymer target matrix, for better workability into polymers, and an additional possible functionalization of the particles is not described.

WO02/096982 describes the production of silica-based nanocomposites by means of extrusion in polymethyl methacrylate. According to this document, the filler is functionalized with silanes, but agglomerated “fumed silica species,” e.g. Aerosile® (registered trademark of Degussa) are used. These are present as an agglomerated powder. Such agglomerates of nanoscale primary particles are only coated with the silane as a whole; the individual primary particles themselves are not completely coated.

WO2004/074361 describes coating of coarse-scale magnesium hydroxide agglomerates having partly reactive additives, such as functionalized silanes. Here, too, dry and thus agglomerated magnesium hydroxide is used in powder form, in order to obtain correspondingly coated agglomerates, but not individually coated magnesium hydroxide particles.

Magnesium hydroxide and aluminum trihydroxide are used in combination with the most varied polymers, as halogen-free mineral fire protection agents. The magnesium hydroxide and/or aluminum trihydroxide fillers used there are used in polymers in coarse-scale form, with filler contents of at least 50 wt.-%. With this filler content, it is possible to achieve the fire class V0 in the fire protection test UL 94 developed by the Underwriter Laboratory in the USA, but the mechanical properties of the plastic clearly suffer from the high degrees of inorganic filling. Frequently, the plastic becomes brittle, and this is connected with a low impact resistance and low values for elongation to tear.

From WO01/92157, micronized barium sulfates are known, along with methods for their production and use. In this connection, coated barium sulfates in nanoscale ranges are described, which find use in cosmetics, adhesives, paints or rubber articles, for example. However, the nanoparticles are made available as a dried powder, and thus as an agglomerated filler.

The present invention is based on the task of making methods available that make the coated magnesium hydroxide particles available in the form of suspensions or dispersions. These coated magnesium hydroxide particles, whose primary particles can lie in the coarse-scale or nanoscale range, can be present in the form of de-agglomerated primary particles or in the form of loose agglomerates (secondary particles).

Another task of the present invention is to make available non-agglomerated, i.e. easily separated agglomerates of coated primary particles.

Another task of the present invention is to make available coated, de-agglomerated magnesium hydroxide particles, in which each individual primary particle carries its own coating.

### DETAILED DESCRIPTION OF THE INVENTION

In a first aspect, the present invention is directed at a method for the production of coated magnesium hydroxide particles, whereby i) a magnesium salt solution is brought into contact with ii) an alkali hydroxide solution, forming a reaction mixture for precipitating coated magnesium hydroxide particles, characterized in that at least one of the following additives A, B and/or C is contained in at least one of the solutions i) or ii) or, when i) and ii) are brought into contact, at least one of the following additives A, B and/or C is simultaneously brought into contact with the reaction mixture that results from i) and ii), whereby the additives are:
a growth inhibitor A,
a dispersant B,
an aqueous stearate solution C or mixtures thereof,
   for the production of an aqueous suspension or dispersion of coated magnesium hydroxide particles.

The magnesium hydroxide particles that can be obtained with the method according to the invention are characterized in that they already receive a coating of the surface during the precipitation process, due to the presence of the aforementioned additives. These both coarse-scale or nanoscale particles consisting of magnesium hydroxide are stabilized electrostatically and sterically by the coating, and thus overly strong re-agglomeration of the particles is inhibited. The polarity of the particles is changed by means of suitable additives and adapted to the polarity of the polymer target matrix.

According to the invention, an aqueous suspension or dispersion of coarse-scale or nanoscale coated magnesium hydroxide particles can thus be made available, in which the primary particles are present in coated and—depending on the selection of the additives—de-agglomerated form, and—depending on the selection of the additives—were changed in such a manner, as a result, that they can subsequently be worked into polymers as fillers.

In this connection, the term “de-agglomerated” means that the secondary particles are not present broken down completely into primary particles, but rather, they are present in clearly less agglomerated or aggregated form than after a drying step of non-coated primary or secondary particles. Because each individual primary particle is present in coated form, any de-agglomeration that might be necessary, even of dried, coated magnesium hydroxide, can be carried out more easily.

In the present case, the term “coarse-scale” is understood to mean a particle size distribution such that the average particle diameter (d50) is greater than 100 nm. In other words, particles in which the particle diameter is greater than 100 nm at more than 50%, such as more than 70%, 80%, particularly more than 90%, such as 95% and particularly 98%, are referred to as coarse-scale particles.

“Nanoscale” are particle size distributions whose average particle diameter (d50) is ≦100 nm. In other words, particles in which the particle diameter is ≦100 nm at more than 50%, such as more than 70%, 80%, particularly more than 90%, such as 95% and particularly 98%, are referred to as nanoscale particles.

The additives that can be used during precipitation according to the invention are, in this connection, a growth inhibitor A (Additive A), a dispersant B (Additive B), an aqueous stearate solution C (Additive C) or mixtures thereof.

As a growth inhibitor A, growth inhibitors known in the state of the art, such as those described in DE 103 57 116 A1, for example, can be used.

The growth inhibitor A is characterized in that it has at least two anionic groups. Preferably, the inhibitor contains at least two of the following groups as anionic groups: a sulfate, a sulfonate, a phosphonate, or a phosphate group, preferably at least two identical ones of these groups. These anionic groups allow anionic coupling of the additive with the surface of the magnesium hydroxide particle. Alternatively, two different anionic groups can also be present.

The growth inhibitors A can be monomers, oligomers or polymers. Of course, the growth inhibitors can also have combinations of two or more of the groups mentioned above.

The growth inhibitor A can also be used as a salt of this compound, whereby the main chain that contains multiple anionic groups and consists of hydrophobic and/or hydrophilic structures can also be branched and/or cyclic. Furthermore, hetero atoms (nitrogen, oxygen, sulfur or phosphorus) can be built into this main chain.

The growth inhibitors A can be present in functionalized form, in other words they can contain one or more reactive end groups, e.g. hydroxy groups. These can later interact with a polymer as a functional group, and form covalent bonds, for example. Here, those covalent bonds that form between OH groups and a diisocyanate, forming a polyurethane, will be mentioned as examples.

Such functionalized growth inhibitors A are, for example, hydroxy-substituted carboxylic acid compounds such as hydroxy-substituted mono and dicarboxylic acids having 1 to 20 carbon atoms, e.g. citric acid, malic acid, dihydroxysuccinic acid, and 2-hydroxyoleic acid. Citric acid and polyacrylates are particularly suitable.

Also, phosphoric acid acrylic compounds having 1 to 10 carbon atoms, which can have additional hydroxy groups, are correspondingly well suited.

Alternatively, compounds that furthermore contain nitrogen atoms can also be used. Suitable compounds are, among others, polyamino compounds such as polyasparaginic acids.

Such reactive groups can furthermore be double bonds, hydroxy, amine, and thiol groups.

The amount of growth inhibitor A can vary. Usually, amounts of 0.1 to 20 wt.-% with reference to the solids content of magnesium hydroxide are used. However, the amount can also be increased to 50 wt.-%, particularly if in addition, a dispersant B and/or stearate C are present. Conduct of an experiment is described in Example 1.

Typical examples of growth inhibitors A are sodium citrate/citric acid, polyacrylates, e.g. Sokalan® PA 20, Dispex® N40 from Ciba-Geigy or polyphosphates, e.g. Calgon® N.

The dispersant B, similar to the growth inhibitor A, has one or more anionic groups in its molecule. Also, it can be present as a monomer, oligomer or as a polymer. The dispersant B can also be used as a salt of this compound, whereby the main chain that contains one or more anionic groups can also be branched or cyclic. They have corresponding hydrophobic and/or hydrophilic structures. These one or more anionic group(s) present in the oligomer or polymer can be, among others, carboxy, phosphonate, phosphate, sulfonate or sulfate groups, which bring about anionic coupling of the dispersant B on the magnesium hydroxide surface. In addition to the anionic groups mentioned, additional main and, if applicable, additional side chains can be present in the molecule of the dispersant B. These can stabilize the resulting particles electrostatically and/or sterically, and thus inhibit re-agglomeration. The dispersants B furthermore allow the resulting magnesium hydroxide suspension or dispersion to stabilize, in order to thereby obtain suspensions or dispersions that are stable in storage. The dispersants B furthermore impart an external polarity to the particle that gives the particle more hydrophobic or more hydrophilic properties, in accordance with the selection of the dispersant, and thereby influences the polarity of these particles to the effect that they are better suited for later use in a polymer matrix, for example, and prevent agglomeration in the polymer, i.e. promote de-agglomeration in the matrix. As a result, these magnesium hydroxide particles, preferably nanoscale magnesium hydroxide particles, can be present in the polymer matrix homogeneously distributed in de-agglomerated form.

In addition to the aforementioned anionic groups, the dispersant B can furthermore contain reactive end groups and thus be functionalized. These functionalized groups comprise hydroxy groups, but also double bonds, amine and thiol groups. Using these functional groups, later covalent linking with a polymer can take place, similar as for the growth inhibitors A described above.

The dispersant B demonstrates good solubility in water, since it is present, according to the invention, either in the magnesium salt solution or the alkali hydroxide solution, or at least is added to the reaction mixture of these two solutions at the same time with the in-situ precipitation.

Suitable dispersants B that can be used in aqueous solvents comprise polyacrylates, such as Sokalan® PA (BASF), for example, polyether carboxylates, such as Melpers® 0030 (BASF), for example, phosphoric acid esters, such as Disperbyk® 102 (Byk-Chemie), for example, or polyphosphates, such as Calgon® N, for example, or polymers having a high molecular weight and filler-affine groups, for example present as a block copolymer, such as Disperbyk® 190, for example.

At the same time, the growth inhibitor A can be a dispersant B, for example in the case of Dispex® N40 (Ciba).

The amount of the dispersant B can vary. Usually, the dispersant B is present in the reaction mixture in an amount of 0.1 to 50 wt.-%, preferably 0.1 to 20 wt.-% with reference to the solids content of Mg(OH)₂. If further processing by means of ultrasound or bead-mill grinding is carried out after the precipitation according to the invention, then the energy to be expended for this is less in comparison with a conventional mechanical comminution process, because here, only de-agglomeration of loose agglomerates has to be carried out, not mechanical breaking up of crystals.

The dispersant B is particularly used in the method according to the invention if a suspension or dispersion that is stable in storage is supposed to be obtained. In particular, if the coated magnesium hydroxide particles that are obtained are supposed to be processed further directly, for example worked into a thermoplastic polymer, precipitation of the magnesium hydroxide is carried out in the presence of the dispersant B.

The group of fatty acids will be mentioned as additives C. These can be present both in straight-line form or also in branched form, saturated, monounsaturated or polyunsaturated, and with different alkyl chain lengths (low, medium, and higher chain lengths). In the following, stearate is mentioned as an example of this additive C.

The stearate solution C is an aqueous stearate solution, for example a sodium or potassium stearate solution. The stearate can be added to one of the aforementioned solutions, i) the magnesium salt solution or ii) the alkali hydroxide solution in solid form, and is therefore present in dissolved form during the precipitation. Because of its carboxy group as an anionic group, the stearate sheathes the primary particles of the magnesium hydroxide that form during precipitation, and coats them accordingly. The stearate itself has no influence on the primary crystal size of the primary particles of the magnesium hydroxide that form. Although the stearate itself does not allow steric stabilization of the particles in aqueous solutions, the sedimented loose magnesium hydroxide agglomerates demonstrate improved de-agglomeration behavior during further processing in the organic medium. This means that coating of the primary particles with stearate allows obtaining suspensions or dispersions of individually coated magnesium hydroxide particles. Even after drying of the suspensions or dispersions, the agglomerates of the coated magnesium hydroxide particles that are then present demonstrate improved de-agglomeration properties.

The amount of sodium stearate used can vary. It lies in the range of 0.1 to 10 wt.-% with reference to the solids content of Mg(OH)₂.

The additives mentioned can also be used as mixtures. For example, a mixture of an aqueous stearate solution C and a growth inhibitor A is preferred as a coating for the primary particles of the magnesium hydroxide. In this connection, the amounts of stearate and growth inhibitor A used lie in the ranges mentioned above, preferably they lie in ranges of 0.1 to 10 Wt.-% with reference to the solids content of Mg(OH)₂ in the reaction mixture.

In this connection, the additives can be added to the reaction mixture separately or together, in the form of an aqueous solution. Alternatively, the additives can be present, together or separately, in one of the starting solutions (alkali hydroxide solution or magnesium salt solution).

The suspensions or dispersions of magnesium hydroxide particles that are obtained can be processed further as such, or can subsequently be dried, for example by means of spray-drying.

The agglomerates of magnesium hydroxide particles obtained when using a combination of stearate solution C and growth inhibitor A can easily be de-agglomerated and processed further.

Because of the use of the growth inhibitor A in combination with the stearate C, the primary particles are present in a nanoscale range, so that nanoscale, coated magnesium hydroxide particles are obtained.

Another preferred embodiment of the method comprises the use of the growth inhibitor A in combination with dispersant B. The dispersions of magnesium hydroxide particles that can be obtained according to the invention demonstrate excellent storage stability without sedimentation and no formation of agglomerates.

In this connection, coated, nanoscale magnesium hydroxide particles are obtained, which are present in the dispersion as de-agglomerated particles, because of the presence of the sterically stabilizing dispersant B. This dispersion can be directly processed further.

Nanoscale, coated, de-agglomerated and preferably functionalized magnesium hydroxide particles that can be obtained demonstrate no tendency to agglomeration when using both growth inhibitor A and dispersant B.

The amount of growth inhibitor A and of dispersant B that is used can vary. It lies in the range of 0.1 to 50 wt.-%, in each instance, with reference to the solids content of Mg(OH)₂ when used in aqueous solvents. Preferred ranges of growth inhibitor A and dispersant B lie at 10 to 50 wt.-%, in each instance, with reference to the solids content of Mg(OH)₂, in order to obtain primary particles having particle sizes of <50 nm. Combinations of 5 to 20 wt.-%, with reference to the solids content of Mg(OH)₂, of growth inhibitor A, and 5 to 30 wt.-%, with reference to the solids content of Mg(OH)₂, of dispersant B make it possible to obtain primary particles having sizes of <100 nm.

As was already explained in general with regard to the additives, the additives growth inhibitor A and/or dispersant B can be used in functionalized form. These two functionalized additives, which are present as a coating on the primary particles of the magnesium hydroxide, bring about a significant improvement in the mechanical properties of the polymer materials after the filler has been worked in.

By means of adapting the polarity of growth inhibitor A and dispersant B to the polarity of the finished polymer, working the magnesium hydroxide particles obtained into monomers, oligomers, and polymers as a filler can be significantly improved by means of better wettability of the particles.

Such plastics can be used, for example, in the sector of flame protection and in the light construction sector. Such polymers are needed, for example, in the sector of boat construction, wind power plants, in the construction of pipelines and containers, etc.

By means of the use of magnesium hydroxide as a filler, lighter components can be obtained, in comparison with the use of barium sulfate or calcium carbonate as fillers. When using functionalized additives, as described above, preferred mechanical properties of the components that can be made from the polymers are obtained.

The magnesium hydroxide particles that can be obtained with the method according to the invention have a diameter of <1000 nm, preferably <500 nm, particularly preferably <100 nm, particularly preferably <50 nm when adding growth inhibitor A by at least 90%, preferably at least 95%, such as at least 98%, particularly preferably at least 99%, particularly 100%.

Particularly by means of the use of the growth inhibitor A, it is possible to control the primary particle size of the magnesium hydroxide particles. This means that the greater the amount of growth inhibitor A, the lower the average particle diameter of the primary particles obtained.

Corresponding to the primary particle size, the primary particles of the magnesium hydroxide that can be obtained with the method according to the invention have a BET surface of at least 50 m²/g, preferably >100 m²/g, such as >120 m²/g, and very particularly preferably >200 m²/g when adding growth inhibitor A. The addition of growth inhibitor A, in particular, allows increasing the specific surface (BET) of the precipitated magnesium hydroxide particles. In this connection, it is found that the greater the amount of growth inhibitor A in the reaction mixture, the higher the specific surfaces (BET) that can be obtained.

Furthermore, it was surprisingly found that the primary particle size and the BET surface can be controlled by means of the temperature of the reaction mixture for precipitation of coated magnesium hydroxide particles.

The method according to the invention can generally be carried out in a temperature range of 0 to 80° C. It was now found that at lower temperatures, small primary particles having great BET surfaces were obtained, for example at 20° C., primary particles at <100 nm having a BET surface of ≧100 m²/g were obtained, while at high temperatures, the primary particles have a greater diameter and the BET values are lower, for example at 80° C., primary particles having a diameter of >800 nm and BET values of <100 m²/g were obtained, without the addition of growth inhibitor A. This means that at increasing temperatures, lower BET values and accordingly larger primary particle sizes are to be expected.

A significant characteristic of the method according to the invention is the ability to coat the primary particles individually, in other words the coarse-scale or nanoscale primary particle that are present in the suspension or dispersion are individually completely coated with the added additives.

In a preferred embodiment, the coated magnesium hydroxide particles obtained during the precipitation process are subjected to a second method step, namely bead-mill grinding or ultrasound treatment.

In another aspect, the present invention is thus directed at methods for the production of coarse-scale and nanoscale magnesium hydroxide particles, whereby at least 90% of the magnesium hydroxide particles have a diameter of <1000 nm, preferably <500 nm, such as <200 nm, particularly <100 nm and particularly preferably <50 nm.

The first method step is characterized in that the coated magnesium hydroxide particles obtained during the precipitation process according to the invention are present as either an aqueous suspension or dispersion, which can also be dried, if necessary (powder form).

The suspensions or dispersions obtained during the first method step (in-situ precipitation) have a solids content of magnesium hydroxide particles of 0.1 to 70 wt.-%.

The liquid or solid (dried) products obtained after the precipitation process can be subjected to another, second method step—namely bead-mill grinding or treatment with ultrasound in the presence of a dispersant B or a dispersant D. In this second method step, aqueous or organic dispersions are obtained.

In this connection, the dispersant D is defined as above under dispersant B. The dispersant B is a dispersant that is soluble in an aqueous solvent. In contrast, the dispersant D is a compound that is soluble in organic solvents.

As an educt of the ultrasound treatment, coarse-scale or nanoscale magnesium hydroxide particles can be used, as they can be obtained with the precipitation process according to the invention. In particular, dried magnesium hydroxide, for example obtained by means of spray-drying, which is present as a nanoscale or coarse-scale but precoated magnesium hydroxide powder, can be used in this ultrasound treatment method step according to the invention.

This magnesium hydroxide powder can be dispersed, on the one hand, in an aqueous solvent, or in an organic solvent. On the other hand, however, the coated magnesium hydroxide particles obtained during the precipitation process can be used directly, as a suspension or dispersion, in the step of the ultrasound treatment. Accordingly, here, since the suspension or dispersion represents an aqueous suspension or aqueous dispersion, a dispersant B is added.

Using the ultrasound treatment, it is possible to de-agglomerate the agglomerated magnesium hydroxide particles. This means that the secondary particles are present in the form of loose agglomerates, and in some cases, the de-agglomeration is so complete that the primary particles are present in isolated form. These de-agglomerated and individually coated magnesium hydroxide particles can then be introduced into curable masses or into thermoplastic polymers, for example, whereby the particles are present in the polymer matrix in de-agglomerated and homogeneously distributed form.

The ultrasound treatment step according to the invention is characterized in that specifically on a large technical scale, a method is made available that is economically practical. The acquisition and operating costs of the devices are low, particularly in comparison with the state of the art.

The dispersant B that can be used in this step can be functionalized, as presented above. This is particularly advantageous for improving the mechanical parameters of the polymers that contain de-agglomerated, coated magnesium hydroxide particles as a filler.

The dispersant D is a dispersant that is soluble in organic solvents and contains anionic groups. The one or more anionic group(s) is(are), for example, sulfonate, sulfate, phosphonate, phosphate or carboxy groups. They allow the corresponding interaction with the surface of the magnesium hydroxide particles. As functionalizations, these dispersants D can have the corresponding reactive end groups in the main and/or side chain, for example double bonds, hydroxy, carboxy, amine, thiol, diisocyanate or epoxy groups. This is particularly advantageous for improving the mechanical parameters of the polymers that contain de-agglomerated, coated magnesium hydroxide particles as a filler.

The dispersants D can be present in low molecular form, as a monomer, an oligomer or as a polymer. They have corresponding hydrophobic and/or hydrophilic structures.

The dispersants B or D are used in amounts of 0.1 to 20 wt.-% with reference to the solids content of Mg(OH)₂.

Examples of the dispersant D are phosphoric acid esters—e.g. Disperbyk® 106 (Byk-Chemie), silanes, e.g. Glymo® (Degussa), and titanates, e.g. Ken-react CP-03® (Kenrich-Petrochemicals). But the polyether carboxylate Melpers® 0030 (BASF) mentioned as a dispersant B can also be used as a dispersant D, since Melpers® 0030 is also soluble in organic solvents, such as n-butanol, for example.

This means that dispersants that fall under the definition of the dispersant B can also represent suitable dispersants D.

The coarse-scale or nanoscale magnesium hydroxide used as an educt is present in (pre)coated form, (pre)coated with at least one of the additives A, B and/or C. The renewed, at least second coating makes it possible to make available coarse-scale or nanoscale multiply coated de-agglomerated and, if necessary, functionalized magnesium hydroxide particles.

Another embodiment relates to a method for the production of nanoscale, coated magnesium hydroxide particles. This second method step is characterized in that the coated magnesium hydroxide particles obtained after precipitation are furthermore subjected to the step of bead-mill grinding in the presence of a dispersant B or a dispersant D.

The magnesium hydroxide particles that can be obtained after bead-mill grinding have a diameter of <500 nm, preferably <150 nm, by at least 90%.

The coated magnesium hydroxide can be used in dried form, for example obtained by means of spray-drying, or as a suspension or dispersion. In dried, powdered form, the magnesium hydroxide is present as a nanoscale or coarse-scale but loosely agglomerated magnesium hydroxide powder. This powder can then be dispersed in an aqueous or organic solvent. The suspension or dispersion then has a dispersant B added to it, in the case of aqueous solutions, or a dispersant D in the case of organic solutions, and subsequently, bead-mill grinding is carried out, as one possibility, in order to obtain coarse-scale or nanoscale, multiply coated, de-agglomerated and, if necessary, functionalized magnesium hydroxide dispersions. The renewed addition, i.e. further coating with the dispersant B or dispersant D prevents re-agglomeration of the magnesium hydroxide particles.

When the second method step is carried out, whether it is ultrasound treatment or bead-mill grinding, it is possible to reduce the amounts of dispersants used, which represent a significant cost factor, both during the precipitation step and during the method step.

Furthermore, it is possible to increase the solids content of magnesium hydroxide in the suspensions or dispersions without having agglomerations occur. This means that the dispersions of coarse-scale or nanoscale, multiply coated magnesium hydroxide particles that can be obtained after ultrasound treatment or bead-mill grinding can have a solids content of 20 to 70 wt.-% magnesium hydroxide.

These dispersions that can be obtained after bead-mill grinding or ultrasound treatment are stable in storage and can be stored, ready for use, or directly processed further. In the case of drying, for example spray-drying, of these dispersions, magnesium hydroxide powders are obtained that are characterized by good and easy re-dispersability and de-agglomerability. Thus, such magnesium hydroxide particles are particularly suitable as fillers in polymers. These polymers find use, for example, for flame protection or in components, for example in components for the aircraft industry.

With the two-step method, the amounts of additives used can be reduced. This means, particularly in the precipitation step of the magnesium hydroxide, lower concentrations of additives A, B and/or C can be used. This is particularly important on a large technical scale.

In a particularly preferred embodiment, the reaction mixture for precipitation of coated magnesium hydroxide particles furthermore contains a growth inhibitor A, in order to obtain nanoscale, coated and, if necessary, functionalized magnesium hydroxide particles. These nanoscale magnesium hydroxide particles can also be worked into the polymers directly.

In another aspect, the present invention is directed at coated primary magnesium hydroxide particles that can be obtained according to at least one of the methods according to the invention.

These coated magnesium hydroxide particles are preferably coarse-scale or nanoscale, coated magnesium hydroxide particles that have a diameter of <1000 nm, such as <500 nm, particularly <200 nm, preferably <100 nm, and particularly preferably <50 nm, by at least 90%, preferably at least 95%.

The coated magnesium hydroxide particles according to the invention, which can be obtained according to one of the methods according to the invention, are furthermore characterized in that they have a BET surface of >100 m²/g, particularly 120 m²/g, such as 150 m²/g, and particularly 200 m²/g.

In a preferred embodiment, these coated magnesium hydroxide particles are functionalized, as described above.

If necessary, the pH of the reaction mixture during precipitation or as a suspension/dispersion during processing can be adjusted to the desired values using suitable acids or bases.

In the following, the invention will be explained in greater detail using examples. These examples serve for a further explanation of the invention, without restricting it to them.

### EXPERIMENTAL EXAMPLES

### Example 1

### In-Situ Method for the Production of a Nanoscale, Coated Magnesium Hydroxide Particle Suspension or Dispersion by Means of a Precipitation Process, Using a Growth Inhibitor A

As a starting solution, a filtered aqueous magnesium chloride solution having a concentration of about 300 g/L was first diluted to a concentration of 0.4 mol/L. 200 mL 0.4 mol/L magnesium chloride solution were presented in an 800 mL beaker glass having a high shape. 0.11 g trisodium citrate as a growth inhibitor A was added to 400 mL of a 0.4 mol/L sodium hydroxide solution and dissolved (see Table 1—Experiment 2). Subsequently, the amount of sodium hydroxide solution, which also contains the growth inhibitor A, was metered into the magnesium chloride solution within two minutes, using a Dosimate. Using an Ultraturrax device (intensive dispersion device, IKA, Germany), intensive mixing took place during metering.

After precipitation, the dispersions were transferred to evaporation bowls and dried in the drying cabinet at 105° C. for hours. The powders obtained in this manner were ground using a mortar, and subsequently the specific surface (BET) of the magnesium hydroxide particles that were obtained was determined (Beckman-Coulter, LS13320).

TABLE 1
Determination of the specific surface of coated
precipitated magnesium hydroxide particles

| | | Amount of growth | Spec. surface |
|---|---|---|---|
| Experiment | Growth inhibitor A | inhibitor A** | (BET) |
| 1 (comparison | — | — | 91 m²/g |
| experiment) | | | |
| 2 | Sodium citrate | 2% | 123 m²/g |
| 3 | Sodium citrate | 10% | 209 m²/g |
| 4 | Dispex N40 | 2% | 127 m²/g |
| 5 | Dispex N40 | 10% | 203 m²/g |

*Dispex ® N40 (Ciba) is an example of a polyacrylate
**with reference to the solids content of Mg(OH)₂

From Table 1, it is clear that the specific surface of the magnesium hydroxide particles obtained increases with an increasing amount of growth inhibitor A, and along with this, the size of the primary particles decreases.

### Example 2

### In-Situ Method for the Production of a Coarse-Scale or Nanoscale, Coated, Functionalized Magnesium Hydroxide Particle Suspension or dispersion by means of a precipitation process, Using a Dispersant B as a Coating

In the following experiment, a polyether carboxylate in dispersant B Melpers® 0030, BASF, 8.5 wt.-% with reference to the solids content of Mg(OH)₂, having terminal reactive OH groups, is used. The experiment was conducted as described in Example 1. The magnesium hydroxide particles obtained had almost identical BET surfaces in comparison with the comparison sample. However, it was shown that the aqueous dispersion obtained was stable in storage over several months.

Furthermore, the magnesium hydroxide particles obtained were easier to de-agglomerate than the particles obtained in the comparison sample.

Furthermore, a phosphoric acid ester—Disperbyk 102® (Byk-Chemie)—was used as an additive as dispersant B. The additive content was 8.5 wt.-% with reference to the solids content of Mg(OH)₂. The product obtained after precipitation in aqueous suspension was dried. The dried product was easy to resuspend in an organic solvent (methylethylketone), was stable in storage as a suspension itself, and did not form any solid agglomerates.

### Example 3

### In-Situ Method for the Production of a Coarse-Scale or Nanoscale, Coated Magnesium Hydroxide Suspension/Dispersion by Means of a Precipitation Process, Using an Aqueous Stearate Solution C as a Coating

The experiment was conducted as described in Example 1, with the exception that instead of growth inhibitor A, a sodium stearate C was dissolved in the sodium hydroxide solution. The concentration was 2 wt.-% sodium stearate C with reference to the solids content of magnesium hydroxide. The precipitation product was subsequently dried and characterized further. The precipitation product formed loose agglomerates, which were easy to de-agglomerate again later. The average particle size of the precipitation product remained almost constant, in comparison with magnesium hydroxide particles in the absence of stearate (see Example 1—Table 1—Experiment 1: BET 91 m²/g).

### Example 4

### In-Situ Method for the Production of a Nanoscale, Coated Magnesium Hydroxide Suspension or Dispersion by Means of a Precipitation Process Using a Mixture of an Aqueous Stearate Solution C and a Growth Inhibitor A as a Coating

The experiment was conducted as in Example 1, with the exception that in addition to the growth inhibitor A, a sodium stearate C was used, 5 wt.-% with reference to the solids content of Mg(OH)₂. While the sodium stearate C was present dissolved in the sodium hydroxide solution, the growth inhibitor A sodium citrate was present in the magnesium chloride solution at a concentration of 2 wt.-% with reference to the solids content of Mg(OH)₂. By combining the two solutions, a precipitation product of magnesium hydroxide particles was obtained, which sedimented rapidly after precipitation, in other words were not stable in storage. After drying the product in the drying cabinet (105° C., 24 hours), the BET surface was determined. The specific surface (BET) was 120 m²/g.

Use of the stearate solution C led to an improvement in the de-agglomeration properties. The additional use of growth inhibitor A led to a reduction in the particle size.

### Example 5

### In-Situ Method for the Production of a Nanoscale, Coated Magnesium Hydroxide Dispersion by Means of a Precipitation Process, Using a Mixture of Growth Inhibitor A and Dispersant B as a Coating

The experiment was conducted as described in Example 1, with the exception that growth inhibitor A and dispersant B were used. This means that a filtered aqueous magnesium chloride solution having a concentration of 300 g/L was presented as the starting solution. This solution was diluted to a concentration of 0.4 mol/L. 200 ml of 0.4 mol/L magnesium chloride solution were presented in an 800 mL beaker glass having a high shape. 1.63 g trisodium citrate as growth inhibitor A were added to 400 mL of a 0.4 mol/L sodium hydroxide solution and dissolved. 5.44 g Melpers® 0030, BASF (dispersant B, pre-complexing and sterically stabilizing agent) were added to the magnesium chloride solution. Subsequently, the amount of sodium hydroxide solution containing the growth inhibitor A was metered into the magnesium chloride solution containing the dispersant, within two minutes, using a Dosimate. Intensive mixing of the reaction mixture took place by means of an Ultraturrax, as described in Example 1.

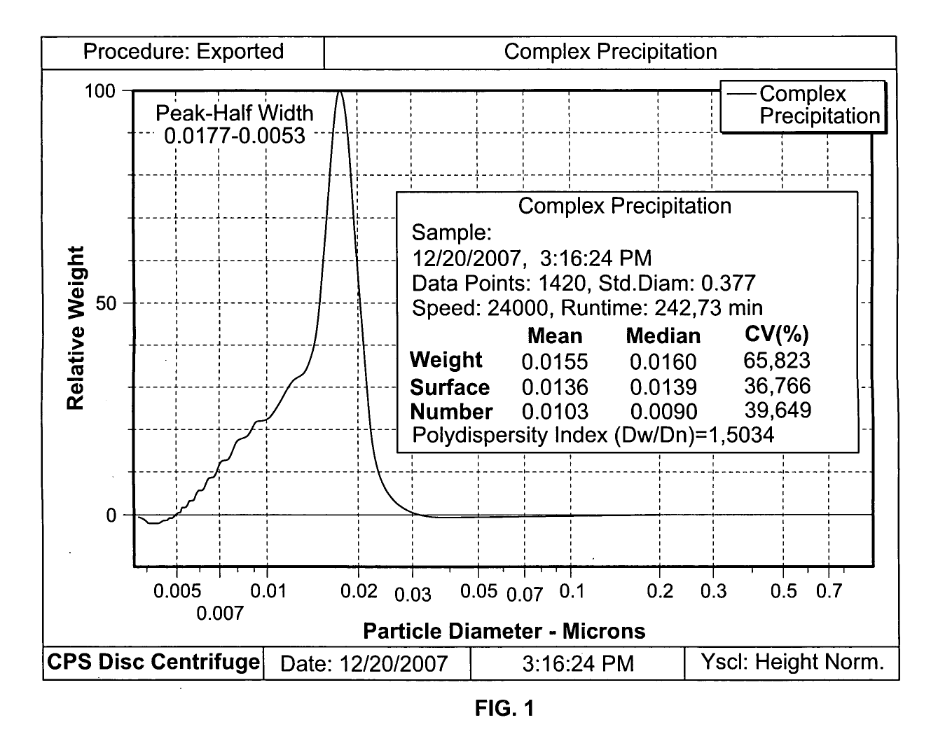

A transparent magnesium hydroxide dispersion having an intensive blue tint, which dispersion is stable in storage, was obtained. Measurements of the particle size showed an average particle size of 16 nm, see FIG. 1. The particle size measurement took place using a LOT-Oriel disc centrifuge CPS, according to known methods.

The narrow particle size distribution can be clearly seen in FIG. 1. By means of the use of a growth inhibitor A and a dispersant B, it is possible to obtain magnesium hydroxide dispersions that are stable in storage, whose primary particles lie in the nanoscale range. These aqueous nanoscale, coated magnesium hydroxide dispersions, which are stable in storage over many years, are characterized by the non-formation of agglomerates. This means that the dispersion does not tend to agglomerate.

The nanoscale, coated, de-agglomerated magnesium hydroxide particles obtained demonstrate reactive OH functionalities (functionalization) because of the use of Melpers® 0030 as dispersant B. Furthermore, long side chains are present. These two properties of the Melpers® 0030 allow a positive influence on the ability of the magnesium hydroxide to be worked into a polymer, and an improvement of the mechanical properties of this polymer that contains this magnesium hydroxide as a filler.

### Example 6

### Production of a Coarse-Scale or Nanoscale, Coated, De-Agglomerated Magnesium Hydroxide Dispersion by Means of Bead-Mill Grinding, with the Addition of Dispersant B as a Coating

Coarse-scale or nanoscale and preferably precoated magnesium hydroxide can be used as an educt; it can be obtained according to one of the methods described in Examples 1 to 5, for example in dried form.

The dried magnesium hydroxide was preground using a ring screen mill (200 μm screen). After grinding, the powder had an average particle size of 6.85 μm (determined by means of Beckmann Coulter LS 13320 in accordance with manufacturer's instructions).

The preground magnesium hydroxide obtained was processed to produce an aqueous suspension, while stirring, in a laboratory dissolver (IKA, Germany, with the addition of distilled water. In order to reduce the viscosity, a dispersant B was added, which also prevents later re-agglomeration of broken-up magnesium hydroxide particles. The dispersant B, in this case polyphosphate Calgon N®, was added in an amount of 3 wt.-% with reference to the solids content of magnesium hydroxide. After a homogeneous suspension having a solids content of 20 wt.-% magnesium hydroxide was produced in the dissolver, it was ground further by means of a stirrer mechanism ball mill AH 90, Hosokawa Alpine AG. The progression of the grinding process was monitored by determining the particle size distribution by means of a Beckmann Coulter LS 13320. An aqueous, coarse-scale, coated and de-agglomerated magnesium hydroxide dispersion having an average particle diameter of 110 nm was obtained.

### Example 7

### Production of an Organic, Coarse-Scale or Nanoscale, Coated, De-Agglomerated Magnesium Hydroxide Dispersion by Means of Bead-Mill Grinding, with the Addition of Dispersant D as a Coating

Alternatively, the bead-mill grinding described was carried out in an organic solvent. The preground and preferably precoated magnesium hydroxide obtained was processed to produce an organic suspension, while stirring, in a laboratory dissolver (IKA, Germany) and with the addition of methylethylketone. In order to reduce the viscosity, a dispersant D was added, which also prevents later re-agglomeration of broken-up magnesium hydroxide particles. The dispersant D, in this case a phosphoric acid ester (Byk 102®, Byk-Chemie), was added in an amount of 8.5 wt.-% with reference to the solids content of magnesium hydroxide. After a homogeneous suspension having a solids content of 40 wt.-% magnesium hydroxide was produced in the dissolver, this suspension was ground further in a stirrer mechanism mill Buhler PML 2. The progression of the grinding process was monitored by determining the particle size distribution with a disc centrifuge (LOT-Oriel). An organic, nanoscale, coated and de-agglomerated magnesium hydroxide dispersion having an average particle diameter (d50) of 85 nm was obtained.

### Example 8

### Production of an Aqueous, Coarse-Scale or Nanoscale, Coated, De-Agglomerated Magnesium Hydroxide Dispersion by Means of Ultrasound, with the Addition of Dispersant B as a Coating

A suspension or dispersion of coated magnesium hydroxide particles obtained in Examples 1 to 5 was mixed with a dispersant B (Sokalan PA20®, 8.5 wt.-% with reference to the solids content of magnesium hydroxide) and pumped in circulation through an ultrasound cell, in which an ultrasound probe (UIP 1000, Hielscher, Germany) was immersed. After about half an hour, starting from 2 liters of a 50% suspension of educt, a nanoscale, coated, de-agglomerated magnesium hydroxide dispersion is obtained that had a narrow particle size distribution. For example, using a coated magnesium hydroxide suspension obtained according to Example 1, it was possible to obtain a corresponding magnesium hydroxide dispersion having an average particle size of 105 nm.

### Example 9

### Production of an Organic, Coarse-Scale or Nanoscale, Coated, De-Agglomerated Magnesium Hydroxide Dispersion by Means of Ultrasound, with the Addition of Dispersant D as a Coating

A suspension or dispersion of coated magnesium hydroxide particles obtained in Examples 1 to 5 was first dried and ground. The powder was subsequently mixed with an organic solvent, here n-butanol, and mixed with a dispersant D (Disperbyk 102®, Byk-Chemie, 8.5 wt.-% with reference to the solids content of magnesium hydroxide) and pumped in circulation through an ultrasound cell, in which an ultrasound probe (UIP 1000, Hielscher, Germany) was immersed. After about half an hour, starting from 2 liters of a 50% suspension of educt, a nanoscale, coated, de-agglomerated magnesium hydroxide dispersion is obtained, which had a narrow particle size distribution. For example, using a coated magnesium hydroxide suspension obtained according to Example 1, which was spray-dried, a corresponding magnesium hydroxide dispersion was obtained, having an average particle size of 92 nm.

As described above, it was possible to obtain a dispersion of coated, de-agglomerated, if necessary functionalized magnesium hydroxide that has nanoscale particles and that can subsequently be used for further processing as a filler in a thermoplastic or duroplastic polymer, using the method according to the invention, with ultrasound treatment.

### Example 10

### Production of an Organic, Coarse-Scale or Nanoscale, Coated, De-Agglomerated Magnesium Hydroxide Dispersion by Means of Ultrasound

The suspension obtained from Example 7 or 9 is dried and subsequently ground (ring screen mill). The multiply coated powder is dissolved in an organic solvent (methylethylketone) and pumped in circulation through an ultrasound cell, in which an ultrasound probe (UIP 1000, Hielscher, Germany) is immersed. After about half an hour, starting from 2 liters of a 50% suspension of educt, a coarse-scale, coated, de-agglomerated magnesium hydroxide dispersion is obtained, which demonstrated a narrow particle size distribution. When using Byk® 106 as a precoating and methylethylketone as a solvent, a magnesium hydroxide dispersion having an average particle size (d50) of nm is obtained.

1-26. (canceled)

27. A method for the production of coated magnesium hydroxide particles, comprising the following steps:
bringing a magnesium salt solution into contact with an alkali hydroxide solution to form a reaction mixture;
adding at least one or a mixture of the following additives
A, B, and C, wherein the additives are:
a growth inhibitor A,
a dispersant B, and
an aqueous stearate solution C; and
precipitating coated magnesium hydroxide particles from the reaction mixture,
wherein the additives are added to at least one of the magnesium salt solution or alkali hydroxide solution prior to mixing, or the additives are brought into contact with the reaction mixture simultaneous with formation of the reaction mixture, to produce an aqueous suspension or dispersion of coated magnesium hydroxide particles.

28. The method according to claim 27, wherein the step of bringing the magnesium salt solution into contact with the alkali hydroxide solution is carried out at temperatures from 0 to 80° C.

29. The method according to claim 27, wherein the additives are a growth inhibitor A and a dispersant B.

30. The method according to claim 27, wherein the additives are a growth inhibitor A and an aqueous stearate solution C.

31. The method according to claim 27, wherein a growth inhibitor A is present in an amount of 0.1 to 50 wt.-% with reference to a solids content of Mg(OH)₂ in the reaction mixture.

32. The method according to claim 27, wherein a dispersant B is present in an amount of 0.1 to 50 wt.-% with reference to a solids content of Mg(OH)₂ in the reaction mixture

33. The method according to claim 27, wherein a stearate C is present in an amount of 0.1 to 10 wt.-% with reference to a solids content of Mg(OH)₂ in the reaction mixture.

34. The method according to claim 29, wherein the growth inhibitor A amounts to 0.1 to 50 wt.-% and the dispersant B amounts to 0.1 to 50 wt.-%, with reference to a solids content of Mg(OH)₂ in the reaction mixture.

35. The method according to claim 30, wherein the growth inhibitor A amounts to 0.1 to 20 wt.-% and the aqueous stearate solution C amounts to 0.1 to 20 wt.-%, with reference to a solids content of Mg(OH)₂ in the reaction mixture.

36. The method according to claim 27, wherein each individual Mg(OH)₂ particle is coated.

37. The method according to claim 27, wherein at least 90% of the particles have a diameter of ≦500 nm each, and further comprising the step of subjecting the coated magnesium hydroxide particles obtained after precipitation to a step of ultrasound treatment or bead mill grinding, in the presence of dispersant B or a dispersant D.

38. The method according to claim 37, wherein during the ultrasound treatment or bead mill grinding, a dispersant B is present in the aqueous suspension or dispersion of the coated magnesium hydroxide particles.

39. The method according to claim 37, wherein the dispersant B is present in an amount of 0.1 to 20 wt.-% with reference to a solids content of Mg(OH)₂.

40. The method according to claim 37, wherein the suspension or dispersion contains a dispersant D.

41. The method according to claim 40, wherein the dispersant D is present in an amount of 0.1 to 20 wt.-% with reference to a solids content of Mg(OH)₂.

42. The method according to claim 27, wherein the growth inhibitor A or the dispersants B or D are used in functionalized form.

43. The method according to claim 27, wherein the step of precipitating takes place in a temperature range of 0 to 30° C., so that BET surfaces of ≧100 m²/g of a precipitation product are obtained.

44. The method according to claim 27, wherein the step of precipitating takes place at a temperature of 31 to 80° C., wherein primary particles having a BET surface of <100 m²/g are obtained.

45. Coated primary magnesium hydroxide particles obtained by the following method:
bringing a magnesium salt solution into contact with an alkali hydroxide solution, to form a reaction mixture;
adding at least one or a mixture of the following additives A, B, and C, wherein the additives are:
a growth inhibitor A,
a dispersant B, and
an aqueous stearate solution C; and
precipitating coated magnesium hydroxide particles from the reaction mixture,
wherein the additives are added to at least one of the magnesium salt solution or alkali hydroxide solution prior to mixing, or the additives are simultaneously brought into contact with the reaction mixture as the reaction mixture is formed, to produce an aqueous suspension or dispersion of coated magnesium hydroxide particles

46. The coated primary magnesium hydroxide particles according to claim 45, wherein at least 90% of the particles have a diameter of ≦100 nm.

47. The coated primary magnesium hydroxide particles according to claim 45, wherein the magnesium hydroxide particles have a BET surface of ≧100 m²/g.

48. An aqueous suspension or dispersion containing coarse-scale and/or nanoscale, coated, de-agglomerated and functionalized magnesium hydroxide particles obtained from a method comprising:
bringing a magnesium salt solution into contact with an alkali hydroxide solution to form a reaction mixture;
adding at least one or a mixture of the following additives A, B, and C, wherein the additives are:
a growth inhibitor A,
a dispersant B, and
an aqueous stearate solution C; and
precipitating coated magnesium hydroxide particles from the reaction mixture,
wherein the additives are added to at least one of the magnesium salt solution or alkali hydroxide solution prior to mixing, or the additives are simultaneously brought into contact with the reaction mixture as the reaction mixture is formed, to produce an aqueous suspension or dispersion of coated magnesium hydroxide particles.

49. The suspension or dispersion according to claim 48, wherein at least 90% of the particles have a diameter of ≦500 nm each, and wherein the coated magnesium hydroxide particles obtained after precipitation are subjected to a step of ultrasound treatment or bead mill grinding, in the presence of dispersant B or a dispersant D

50. The suspension or dispersion according to claim 48, wherein the suspension or dispersion has a solids content of magnesium hydroxide particles of 0.1 to 70 wt.-%.

51. The suspension or dispersion according to claim 49, wherein the suspension or dispersion has a solids content of magnesium hydroxide particles of 20 to 70 wt.-%.
